(19) United States
(12) Patent Application Publication
(10) Pub. No.: US 2020/0074831 A1
(43) Pub. Date: Mar. 5, 2020

(54) HYBRID MARKER FOR AUGMENTED REALITY SYSTEM

(71) Applicant: Tytus3D System Inc., Fremont, CA (US)

(72) Inventors: Jerald YUN, Pleasanton, CA (US); Hon S. YI, San Jose, CA (US)

(73) Assignee: Tytus3D System Inc.

(21) Appl. No.: 16/558,036

(22) Filed: Aug. 30, 2019

Related U.S. Application Data
(60) Provisional application No. 62/724,694, filed on Aug. 30, 2018.
(60) Provisional application No. 62/724,683, filed on Aug. 30, 2018.

(51) Int. Cl. G08B 21/12; G06T 7/73; G08B 21/04; G06T 7/90; G08B 21/18

(52) U.S. Cl. CPC G08B 21/12; G06T 7/73; G06T 2207/30204; G06T 7/90; G08B 21/182; G08B 21/0492

(57) ABSTRACT

Disclosed is a method and system, utilizing augmented reality, for displaying hazards which is harmful to people those involved in manufacturing environment. The system comprises one or more light sources, one or more image markers, one or more signal transceivers, one or more manufacturing machines, one or more safety light poles coupled to the manufacturing machines, an online platform, and one or more portable display devices. A hybrid marker is introduced for providing pattern recognition effectively, wherein the marker is either invisible or a visual image. The one or more light sensors in the portable display device detects light signal, and the one or more transceivers detects wireless signal, the signal indicating hazardous information. The hazardous information is displayed as two-dimensional images to the augmented reality system.

### CROSS-REFERENCE TO A RELATED APPLICATION

This application is a nonprovisional of claims the benefit of and priority to U.S. Provisional Patent Application No. 62/724,694, filed Aug. 30, 2019, inventors Ilgoo Hwang et al., titled “HYBRID MARKER FOR AUGMENTED REALITY SYSTEM FOR MANUFACTURING ENVIRONMENT” and U.S. Provisional Patent Application No. 62/724,683, filed Aug. 30, 2019, inventors Ilgoo Hwang et al., titled “HYBRID MARKER FOR AUGMENTED REALITY APPLICATION” which are commonly assigned herewith, and all of which are hereby incorporated herein by reference in its entirety with the same full force and effect as if set forth in its entirety herein.

### FIELD OF THE INVENTION

The present disclosure generally relates to Augmented Reality (AR) technologies, in particular, to methods and systems implementing AR via identifying hybrid markers in safety warnings.

### BACKGROUND OF THE INVENTION

The introduction of additive manufacturing technologies has the potential to transform modern industrial production, but it also brings new considerations for manufacturers and their employees. These considerations include potential safety risks associated with additive manufacturing production facilities, equipment and materials.

Safety concern could be metal powders used as input materials, or the system's high-powered laser used to fuse the metal powder, or inert gas for preventing explosion, or overheated build platform after manufacturing, or others. The raw metal powders used as input materials may cause irritation to eyes and skin. They are also harmful if inhaled and may cause pulmonary fibrosis. Metal additive machines often use some type of inert gas, such as argon and nitrogen, to manage the flammability and explosion potential of metal powers. A caution about these gases—nitrogen and argon will displace oxygen in a room. They don't smell and there's no color, so no one will know if there is a leak, until people in the room start passing out. The build platform is heated up to certain degrees and kept at this temperature during the build in order to remove any residual moisture that may be present in the powder. A user may get burn from an abnormal overheated build platform after build, even though the user did pay attention using heat-resistant gloves.

It generally may generate alert messages to users, when these hazards occur on the site. Beside the user, however, co-workers who approach to them from distance, or a part from them doing other works, may get injured by these hazards without warnings. Additionally, if there are a plurality of equipment detecting hazards in one place, it may be difficult to notify the precise location where the hazard occurs.

When a supervisor or a co-worker on the site uses wearable display having a camera or a signal receiver, for example, a Head-Mounted-Display (HMD), thereby scan the environment, the device may miss any safety alert due to disruptions from multiple sensing by a plurality of equipment. Conventional images or Quick Response (QR) Code to indicate the location may bring inaccurate information or may not be recognized due to its resolution or angle limitation. Other methods, such as receiving signal from the Global Positioning System (GPS) to navigate the hazard site may not work in-door environment.

There is a need for precisely identifying safety alerts from one or more additive manufacturing machines for portable display having augmented reality system and operable in-door or out-door environment.

### SUMMARY OF THE INVENTION

The following presents a simplified summary of the disclosure in order to provide a basic understanding of some aspects. This summary is not an extensive overview of the disclosure. It is not intended to identify key/critical elements of the disclosure or to delineate the scope of the disclosure. Its sole purpose is to present some concepts of the disclosure in a simplified form as a prelude to the more detailed description that is presented later.

The disclosure presented and claimed herein, in one aspect thereof, includes apparatus and methods of a hybrid marker for augmented reality system configured to identify hazards from manufacturing environment.

An additive manufacturing machine is used for fabricating three-dimensional work pieces. People present in manufacturing environment may be exposed in unexpected hazardous situations. Raw metal powders used as input materials are harmful if inhaled and may cause serious diseases. Inert gas for preventing explosion is also harmful, as well as unexpectedly overheated build platforms. The manufacturing machine may have various safety sensors for detecting safety issues. An exemplary embodiment of the disclosure, once one of the sensors detects hazards, it may generate a safety alert from a safety light pole installed on the top of the manufacturing machine.

Another exemplary embodiment of the disclosure, people wearing a portable display device, such as Head-Mounted Display (HMD), or carrying a tablet PC equipped with Personal Protective Equipment (PPE), can monitor a worksite for detecting any hazardous situation. Unlike users who work on the job site immediately could be notified the hazard information, people a part from the user or people approaching to the user may not be notified in real-time when the hazard is being detected. The portable display device equipped an augmented reality system, thereby it displays hazardous information to the user when the sensor detects the hazards from the worksite.

One exemplary embodiment of the disclosure, the machine may generate multiple safety alerts by flashing lights and transmitting invisible signals, in order not to miss important safety warnings, in addition to alert all the people involved in the situation. The portable display device captures those alerts from a light sensor and a transceiver when the user monitors on the worksite. Not to mention, online platform or network virtually connected to the Beacon application, also transmit alerts to user in remote environment by presenting illustration. In this present disclosure of an embodiment, the lighting method could be Morse Code flashing LED lights in addition to the safety light pole, LED light strip with signals, Infra-red light, Ultra-violet light, or others. RF signal may be transmitted along with the light signal. The Bluetooth Low Energy (BLE), or other transmittable technology could be adopted besides the RF signal.

The other exemplary embodiment of the disclosure, the camera may capture a maker of sign board, either visible image or invisible image, and the image processor recognizes the pattern of the marker.

The disclosed exemplary embodiment, the user may see the overlaid hazard information in the augmented reality through the portable display, either on the worksite or remotely. Another disclosed exemplary embodiment, the light beacon may be used both in-door and outdoor.

### BRIEF DESCRIPTION OF THE DRAWINGS

The objects, features and advantages of the present invention will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 (or “FIG. 1”) schematically illustrates an example embodiment of a marker for augmented reality system.

FIG. 2 (or “FIG. 2”) schematically depicts an embodiment including a marker for augmented reality system.

FIG. 3 (or “FIG. 3”) is an enlarged, partial, front view of an additive manufacturing machine.

FIG. 4 (or “FIG. 4”) is a partial plan view of lighting strip.

FIGS. 5A to 5B (or “FIGS. 5A-5B”) are block diagrams illustrating a marker for an augmented reality system according to the present invention.

FIG. 6 (or “FIG. 6”) is a process flow diagram illustrating an example method of implementing augmented reality using a marker.

### DETAILED DESCRIPTION OF REPRESENTATIVE EMBODIMENTS

The present disclosure is to be considered as an exemplification of the principles of the invention and is not intended to limit the invention to the specific embodiments illustrated. In this respect, it is to be understood that the invention is not limited in its application to the details of construction and to the arrangements of components set forth above and below, illustrated in the drawings, or as described in the examples. Systems, methods and apparatuses consistent with the present invention are capable of other embodiments and of being practiced and carried out in various ways.

Generally described, this disclosure contributes an immediate safety alert for identifying hazardous information using marker in augmented reality system.

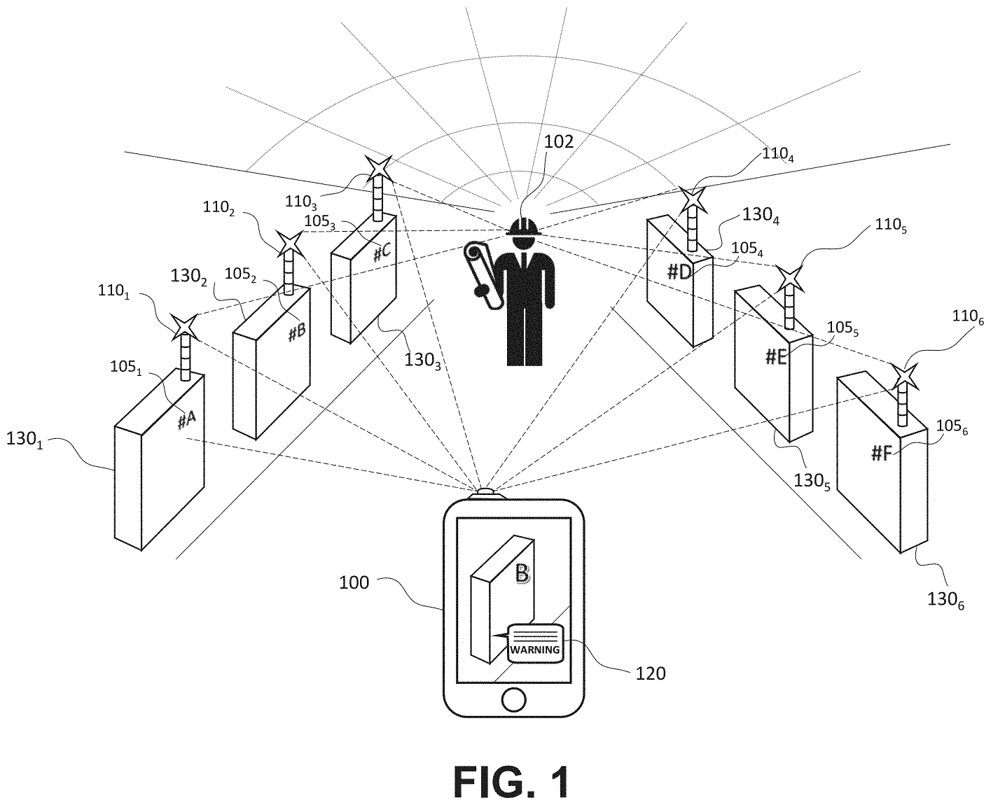

FIG. 1 schematically illustrates an example embodiment of a marker for augmented reality system. There may be one or more additive manufacturing machines 130n on work site. Each machine 130n has sensors to detect hazardous information, such as leaking inert gas, or dispersing metallic powders in the air, unexpectedly overheated even after manufacturing, so that a safety light pole 110n which is installed on top of the machine 130n is capable to generate safety warning signal 111n. A portable display 100, for example, a Head-Mounted Display (HMD), or a table PC, can capture hazardous information provided by the machine 130n. The portable display 100 has an augmented reality system showing hazardous information in real-time. The captured hazardous information can be transmitted in visualized form or in illustrated form to connected one or more portable display devices 100 either on the work site or in remote. Additionally, the captured hazardous information would be illustrated as an intuitive form 120, or simplified form, in augmented reality system.

Another instances, the marker may be used for a commercial platform. There may be many stores in shopper center and each store has a signboard along with a marker and a light source. A portable display has an image recording device so that the image sensor is capable to capture a visible or invisible marker, light signals from one or more light sources. The portable display device may display an overlaid pop-up message tracking any target object, or the like.

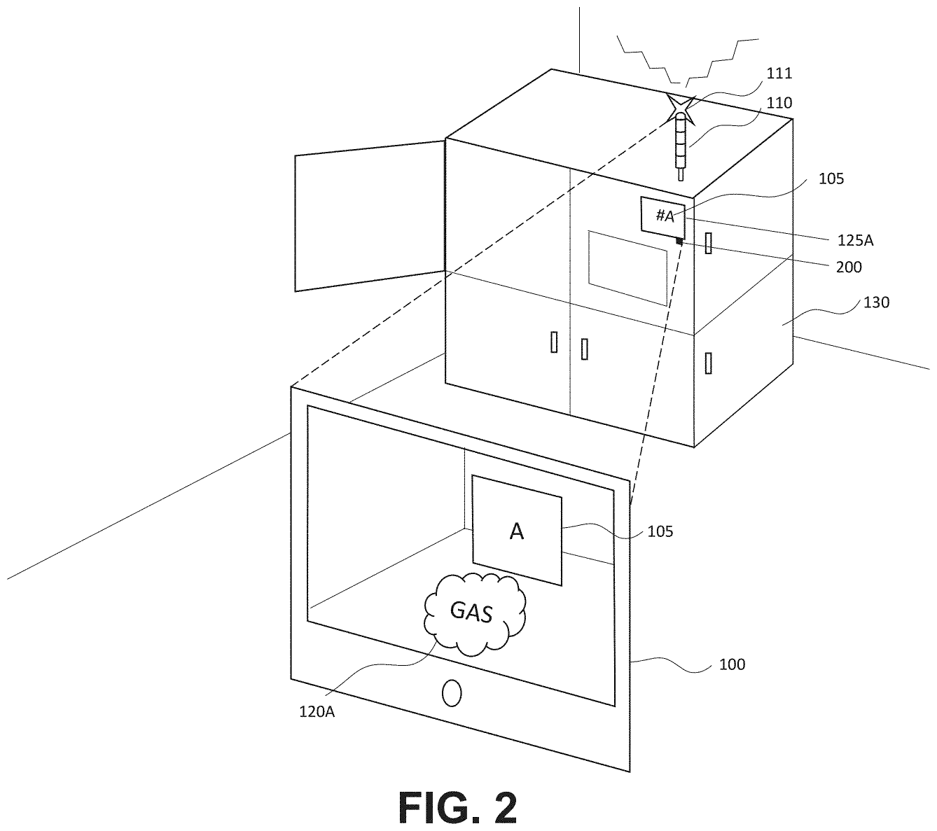

FIG. 2 schematically depicts an embodiment including a marker for augmented reality system. The manufacturing machine generates a safety alert when it detects a hazardous information, for example, leaking inert gas, or dispersing powders, or others. The safety light pole 110 installed top of the machine 130 begins generating warning signal by lighting up 111 its light which may have one or more color blocks. Additional lightings, in dome shape or in other shapes, may be installed on the top of the safety light pole, to flash the light for generating additional signals, such as MORSE Code flashing LED light. The lighting signal would have different pattern per each hazardous information, as well as each machine. A portable display 100 having an image recording device, such as a visible ray camera, an infra-red ray camera, an ultra-violet ray camera, or others, would scan a visual marker 105, such as on a sign board 125A of the machine 130 attached thereto, or marker itself. The visual marker 105 could be a visible image, an invisible tag, Quick Response (QR) Code, or others. Additionally, a light sensor installed to the display device also captures a warning signal 111 generated by the top of the safety light pole 110, and an image processor of the display device recognizes the signal 111 since the pattern of the signal 111 indicates specific hazardous information 120A.

Another instances, an invisible marker 200, such as Radio Frequency (RF) signal, Bluetooth Low Energy (BLE) Beacons, or any other signals may be connected to Internet of Things (IoT), is generating the identical safety alert message indicating the hazardous information 120A. Optionally, the RF signal may be used to measure distance between hazard-occurred-location and the person who holds the portable display device 100.

For example, in case of leaking inert gas as identified in FIG. 2, the user may see an intuitive image 120A or illustrations 120A indicating the hazardous information 120A with the specific location 105 from the augmented reality screen which may be simplified information read from the marker 105 of the machine 130.

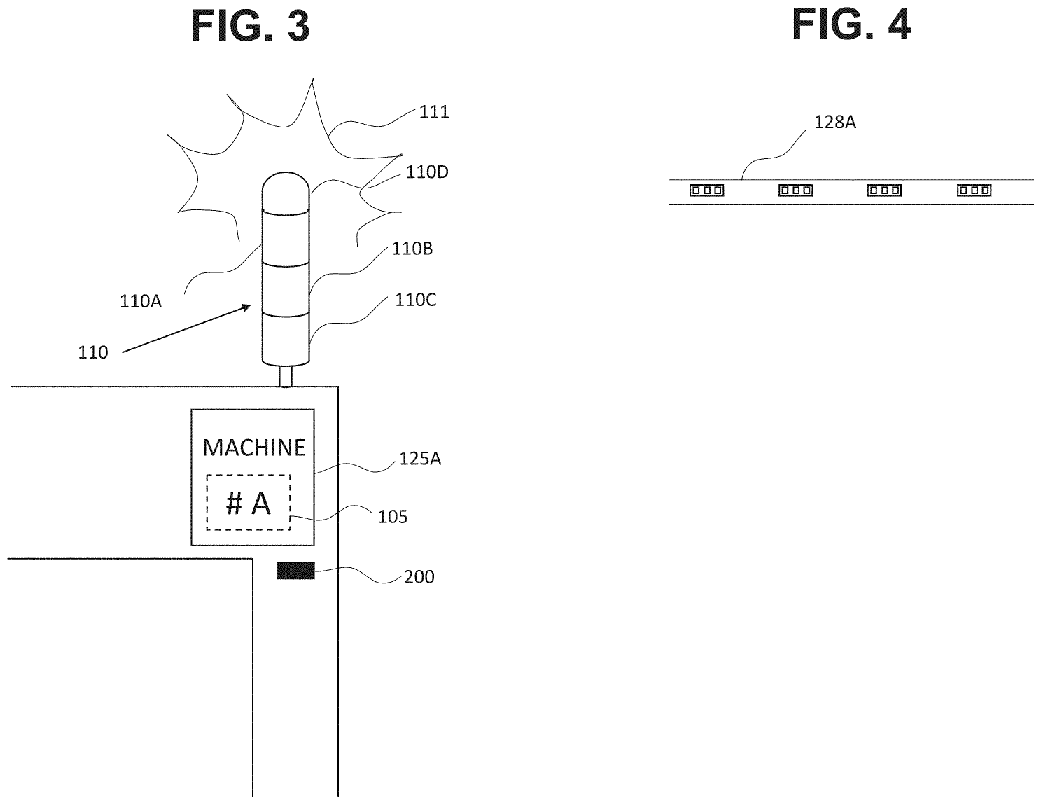

FIG. 3 is an enlarged, partial, front view of an additive manufacturing machine illustrating the safety light pole 110, visual marker 105 such as on a sign board 125A, and invisible marker 200 such as RF signal. The safety light pole 110 has one or more color-blocks, for example, red, green, and yellow. Each color block 110A, 110B, 110C, and 110D has own lighting pattern, so that the light signal 111 is distinguishable from other light signals. The sign board 125A of the machine 130 indicates visual marker 105. The image recording device of the portable display device 100 is scanning the visual marker 105 and process the image to find where the location is. An invisible signal, such as RF signal but not limited to, is transmitting from the upper right front part of the machine 130.

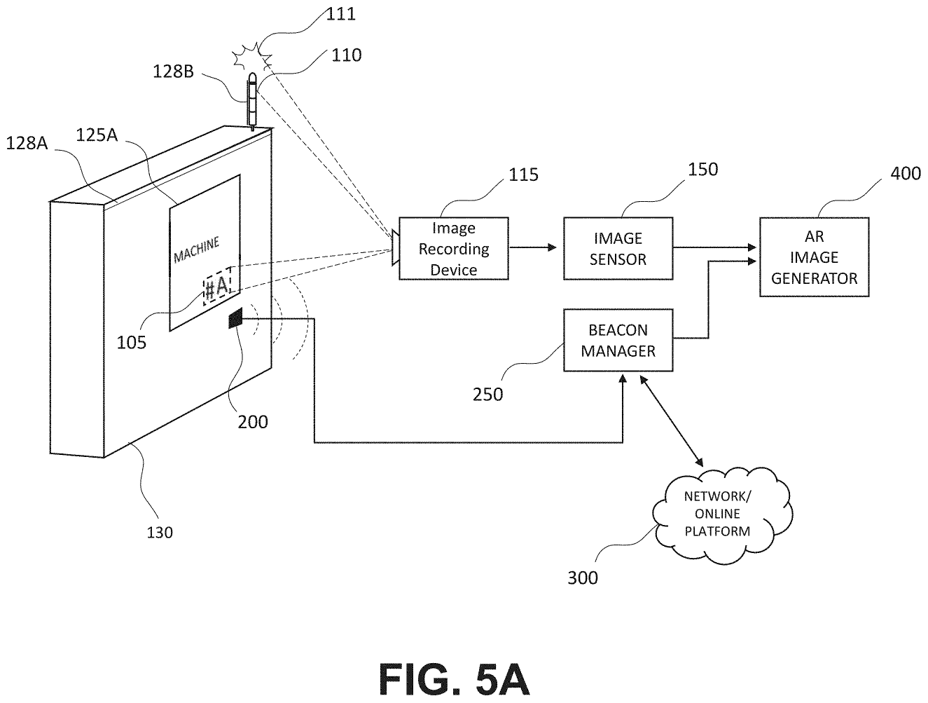

FIG. 4 is a partial plan view of a lighting strip 128A. The light signal source may be a series of LEDs, not limited to the dome-shape LED lights. Lighting pattern may be different according to each hazardous situation. It may be attached to the top of the machine 130 or along with the safety light pole 110.

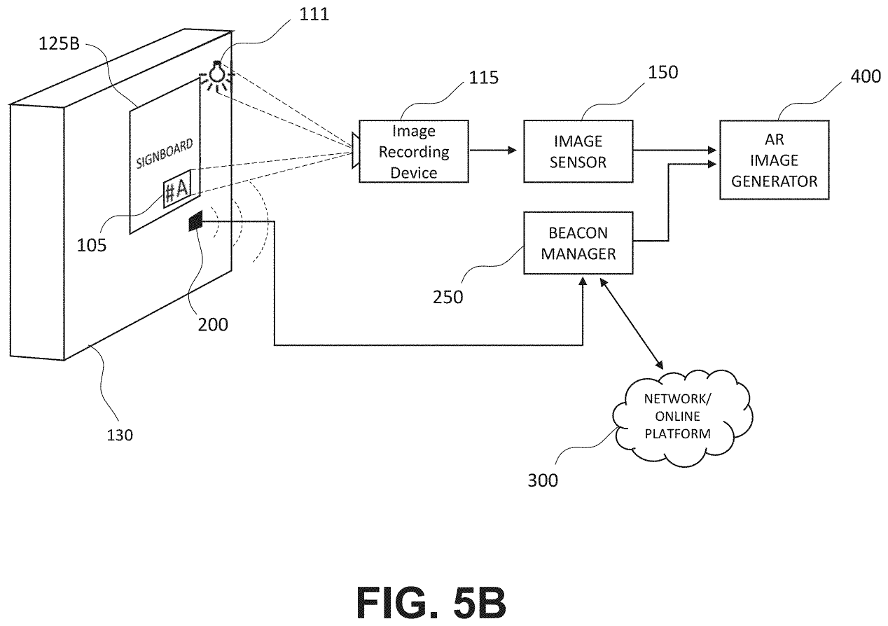

FIGS. 5A to 5B are block diagrams illustrating a hybrid marker for an augmented reality system according to the present invention. The augmented reality system in manufacturing environment can be depicted by sensing various information such as image recognition, light signal recognition, or RF signal recognition. In case of Beacon technology, there is an external network or online platform to communicate the beacon manager, such as beacon application installed to the portable display device. The Beacon may work with Apple's iOS or Google's Android, but not limited to. The maximum range of beacons may be around 230 feet (70 meters). It can be also adjusted in several different levels. Once an image processor receives data from the camera, image sensor detects lighting signals from one or more light sources, and Beacon application recognizes signals from one or more machines, the AR image generator works for augmented reality system. This process occurs in real-time. Besides, the maker such as light beacon can be used outdoors besides used for safety warning messages, for example, proximity location based marketing in case of having personal network.

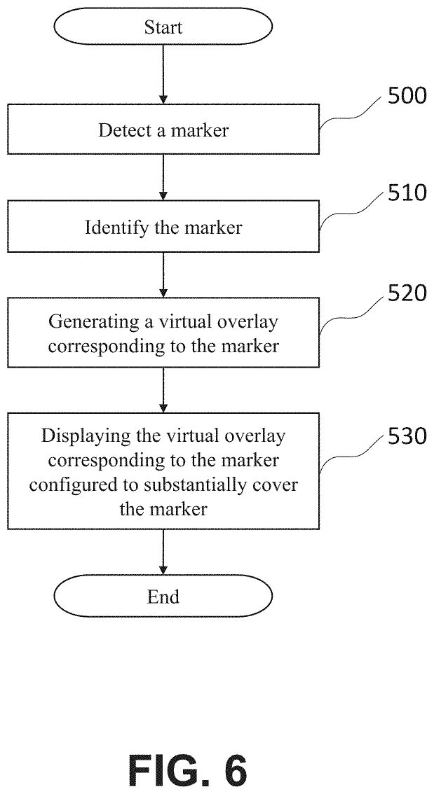

FIG. 6 is a process flow diagram illustrating an example method of implementing augmented reality using a marker. A marker may be detected 500 by an image recording device 115 while scanning the environment, otherwise detected by an RFID tag, BLE beacon device, or others. The marker would be a visible image, invisible IR image, or RF image. An image processor is identifying the marker 510 and generating a virtual overlay corresponding to the marker 520. Then, the augmented reality application displays the virtual overlay corresponding to the marker 530. The virtual overlay covers the marker of the screen.

The present disclosure is to be considered as an exemplification of the principles of the invention and is not intended to limit the invention to the specific embodiments illustrated. In this respect, it is to be understood that the invention is not limited in its application to the details of construction and to the arrangements of components set forth above and below, illustrated in the drawings, or as described in the examples. Systems, methods and apparatuses consistent with the present invention are capable of other embodiments and of being practiced and carried out in various ways.

Other aspects and embodiments of the present invention may be obvious having viewed this particular detailed description of the present invention. However, this detailed description is intended to be educational and instructive and is not intended to be limiting upon the scope and content of the following claims. For example, the adapter for dispensing content may have configurations other than the embodiments of the support apparatus 100A, 100B shown in FIGS. 1-6C. In alternate embodiments (not shown), the adapter for dispensing content may be a combined one with the inflatable sealing mechanism and the threaded sealing mechanism. Accordingly, the invention is not limited except as by the appended claims.

Although the invention has been described with respect to specific embodiments thereof, these embodiments are merely illustrative and not restrictive of the invention. In the description herein, numerous specific details are provided, such as examples of electronic components, electronic and structural connections, materials, and structural variations, to provide a thorough understanding of embodiments of the present invention. One skilled in the relevant art will recognize, however, that an embodiment of the invention can be practiced without one or more of the specific details, or with other apparatus, systems, assemblies, components, materials, parts, etc. In other instances, well-known structures, materials, or operations are not specifically shown or described in detail to avoid obscuring aspects of embodiments of the present invention. In addition, the various Figures are not drawn to scale and should not be regarded as limiting.

Reference throughout this specification to “one embodiment”, “an embodiment”, or a specific “embodiment” means that a particular feature, structure, or characteristic described in connection with the embodiment is included in at least one embodiment of the present invention and not necessarily in all embodiments, and further, are not necessarily referring to the same embodiment. Furthermore, the particular features, structures, or characteristics of any specific embodiment of the present invention may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

It will also be appreciated that one or more of the elements depicted in the Figures can also be implemented in a more separate or integrated manner, or even removed or rendered inoperable in certain cases, as may be useful in accordance with a particular application. Integrally formed combinations of components are also within the scope of the invention, particularly for embodiments in which a separation or combination of discrete components is unclear or indiscernible. In addition, use of the term “coupled” herein, including in its various forms such as “coupling” or “couplable”, means and includes any direct or indirect electrical, structural or magnetic coupling, connection or attachment, or adaptation or capability for such a direct or indirect electrical, structural or magnetic coupling, connection or attachment, including integrally formed components and components which are coupled via or through another component.

Furthermore, any signal arrows in the drawings/Figures should be considered only exemplary, and not limiting, unless otherwise specifically noted. Combinations of components of steps will also be considered within the scope of the present invention, particularly where the ability to separate or combine is unclear or foreseeable. The disjunctive term “or”, as used herein and throughout the claims that follow, is generally intended to mean “and/or”, having both conjunctive and disjunctive meanings (and is not confined to an “exclusive or” meaning), unless otherwise indicated. As used in the description herein and throughout the claims that follow, “a”, “an”, and “the” include plural references unless the context clearly dictates otherwise. Also as used in the description herein and throughout the claims that follow, the meaning of “in” includes “in” and “on” unless the context clearly dictates otherwise.

“optional” or “optionally” means that the subsequently described event or circumstance may or may not occur, and that the description includes instances where the event occurs and instances where it does not.

The foregoing description of illustrated embodiments of the present invention, including what is described in the summary or in the abstract, is not intended to be exhaustive or to limit the invention to the precise forms disclosed herein. From the foregoing, it will be observed that numerous variations, modifications and substitutions are intended and may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

What is claimed is:

1. Method for displaying safety alert in augmented reality application comprising:
sensing hazards in a first range of a manufacturing machine;
generating safety alert by a safety light pole coupled to the manufacturing machine;
flashing light signal in pattern from one or more LED lights connected to the safety light pole;
transmitting Radio Frequency (RF) signal from one or more transmitters;
monitoring a place where one or more manufacturing machines locate by portable display device having an image recording device, one or more light sensors, and one or more signal detection sensors;
detecting hazardous information in a second range from one or more markers;
image processing from recognized pattern; and
overlaying an augmented reality display on a portable display device.

2. The method of claim 1, wherein the hazards are leaking inert gas, dispersing powder, and/or an overheat after build.

3. The method of claim 1, wherein the first range of a manufacturing machine is a range that one or more sensors installed on manufacturing machine detects hazards.

4. The method of claim 1, wherein the safety light pole is located on the top of the manufacturing machine, the safety light pole further comprising a green color block, a red color block, and a yellow color block.

5. The method of claim 1, wherein RF signal is replaceable with Bluetooth Low Energy Beacon signal, or Ultrasonic Beacon wave.

6. The method of claim 1, wherein flashing light signal in pattern is a Morse Code flashing LED light.

7. The method of claim 1, wherein the second range from one or more markers is a range that the transceiver detects signals.

8. The method of claim 1, wherein the recognized pattern is from visual marker, or invisible marker.

9. A system for identifying markers and implementing augmented reality environment comprising:
an image processor unit configured to detect one or more markers and light signals, wherein the marker is visible or invisible image;
an optical sensor configured to capture an optical image;
an RF sensor assembly configured to receive an RF signal;
a transceiver configured to receive RF signals;
a processor configured to receive data, the data representing the image and the RF signal; and
a memory configured to store the data representing the RF signal.

10. The system of claim 1, wherein the light signal is morse code flashing light

11. The system of claim 4, wherein the morse code flashing light is a visual signal, IR ray, or UV ray.

12. A method of implementing virtual objects in an augmented reality application comprising:
detecting a marker;
detecting a morse code flashing light;
detecting an RF signal;
identifying a virtual overlay corresponding to the marker, the flash light, and the RF signal; and
displaying the virtual overlay corresponding to the marker, the flash light, and the RF signal.
